(19) United States
(12) Patent Application Publication
(10) Pub. No.: US 2010/0096825 A1
(43) Pub. Date: Apr. 22, 2010

(54) FENDER ASSEMBLIES AND VEHICLES INCLUDING SAME

(76) Inventors: Daisuke Nagao, Long Beach, CA (US); Kenji Tamura, Redondo Beach, CA (US)

Correspondence Address: ULMER & BERNE, LLP;ATTN: DIANE BELL, 600 VINE STREET, SUITE 2800, CINCINNATI, OH, 45202, US

(21) Appl. No.: 12/254,950

(22) Filed: Oct. 21, 2008

(51) Int. Cl. B62D 25/18

(52) U.S. Cl. 280/152.05

(57) ABSTRACT

A fender assembly for a vehicle includes a fender panel and an arm. The arm is attached to the fender panel and is configured for attachment with respect to a frame of the vehicle. The arm at least substantially entirely supports the fender panel at a position to cover at least a portion of a wheel of the vehicle. Vehicles including a fender assembly are also disclosed.

### TECHNICAL FIELD

A fender assembly is provided for a vehicle, such as a motorcycle. In one embodiment, the fender assembly comprises a fender panel and an arm, wherein the arm attaches the fender panel to the remainder of the vehicle.

### BACKGROUND

A fender assembly is conventionally attached to a vehicle at a position to at least partially cover one or more wheels present upon the vehicle. A fender assembly can accordingly block debris from projecting or splashing up from the wheel(s) and onto an operator and/or other component(s) of the vehicle. A conventional motorcycle includes a fender assembly which is attached to the motorcycle's frame at multiple attachment locations. The use of multiple attachment locations can contribute to a bulky appearance of such a fender assembly, and can require excessive time, complexity and cost for installation.

### SUMMARY

In accordance with one embodiment, a motorcycle comprises a frame, a front wheel rotatably supported with respect to the frame, a rear wheel rotatably supported with respect to the frame, and a fender assembly. The fender assembly comprises a fender panel and an arm. The arm has a first end and a second end. The first end of the arm is attached to the fender panel while the second end of the arm is attached to the frame of the motorcycle. The arm extends along a longitudinal axis of the motorcycle and at least substantially entirely supports the fender panel at a position to cover at least a portion of one of the front wheel and the rear wheel.

In accordance with another embodiment, a vehicle comprises a frame, a front wheel rotatably supported with respect to the frame, a rear wheel rotatably supported with respect to the frame, and a fender assembly. The fender assembly comprises a fender panel and an arm. The fender panel has a top surface and a bottom surface. The arm has a first end, a second end, an upper surface, and a lower surface. The first end of the arm is attached to the fender panel such that the lower surface of the arm contacts the top surface of the fender panel. The second end of the arm is attached to the frame of the vehicle. The arm and the fender panel extend along a longitudinal axis of the vehicle. In addition, the arm extends at least partially over at least a portion of the rear wheel. The arm at least substantially entirely supports the fender panel at a position to cover at least a portion of the rear wheel.

In accordance with yet another embodiment, a fender assembly for a vehicle comprises a fender panel and an arm. The arm has a first end and a second end. The first end of the arm is attached to the fender panel and the second end of the arm is configured for attachment with respect to a frame of a vehicle such that the arm at least substantially entirely supports the fender panel at a position to cover at least a portion of a wheel of the vehicle.

### BRIEF DESCRIPTION OF THE DRAWINGS

While the specification concludes with claims particularly pointing out and distinctly claiming the present invention, it is believed that the same will be better understood from the following description taken in conjunction with the accompanying drawings in which:

FIG. 1 is a right side elevational view depicting a motorcycle having a fender assembly in accordance with one embodiment;

FIG. 2 is a left side elevational view depicting the motorcycle of FIG. 1;

FIG. 3 is a top perspective view depicting a portion of the motorcycle of FIGS. 1-2;

FIG. 4 is an exploded view depicting the fender assembly of FIGS. 1-3 as being disassembled;

FIG. 5 is a perspective view depicting a portion of a motorcycle in accordance with another embodiment; and

FIG. 6 is a perspective view depicting a portion of a motorcycle in accordance with yet another embodiment.

### DETAILED DESCRIPTION

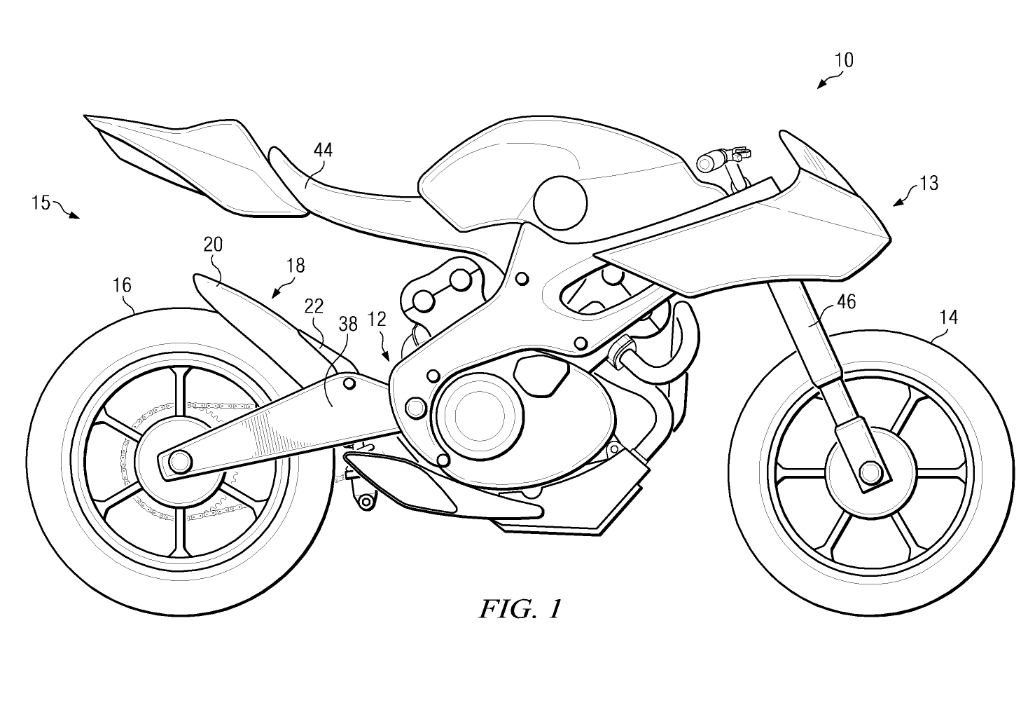

Embodiments are hereinafter described in detail in connection with the views of FIGS. 1-6, wherein like numbers indicate the same or corresponding elements throughout the views. A fender assembly in accordance with one embodiment can be configured for attachment to a vehicle such as, for example, a motorcycle, scooter, bicycle, all terrain vehicle, automobile, truck, aircraft, golf cart, or van.

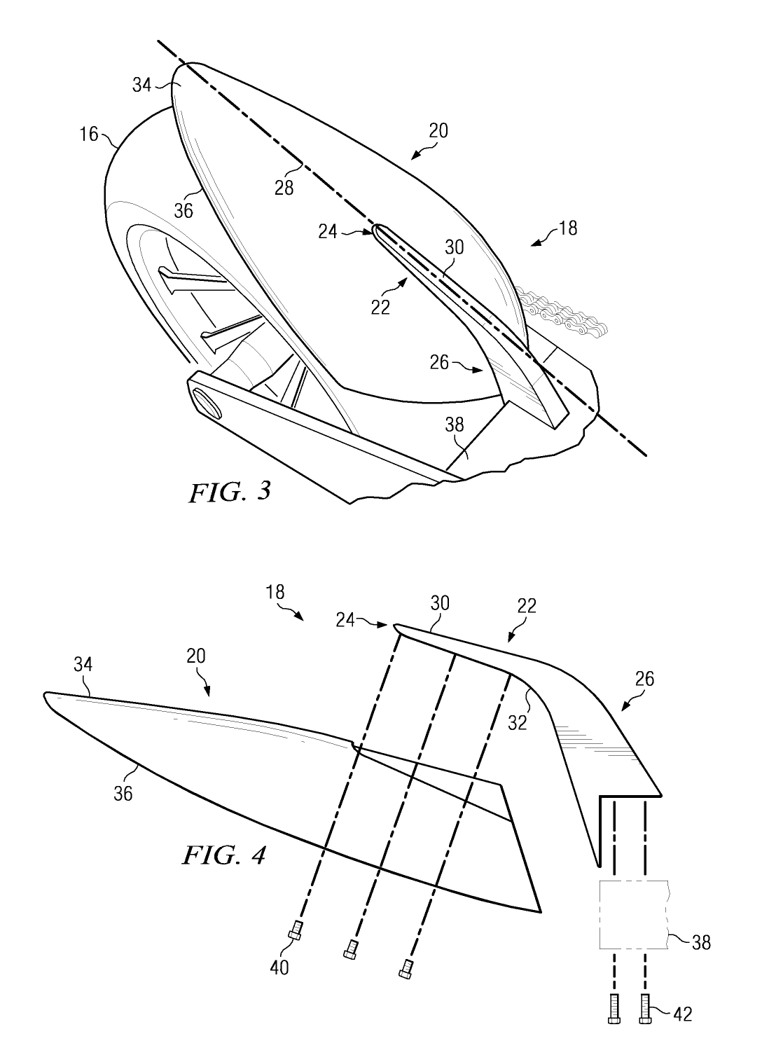

In one particular embodiment, as depicted in FIGS. 1-4, a motorcycle 10 is shown to include a frame 12, a seat 44, a front wheel 14, and a rear wheel 16. The motorcycle 10 extends along a longitudinal axis (28 in FIG. 3) from a front end 13 to a rear end 15. The front wheel 14 is shown to be rotatably supported with respect to the frame 12 adjacent to the front end 13 of the motorcycle 10. In particular, the frame 12 is shown to comprise a fork 46 which rotatably supports the front wheel 14. The rear wheel 16 is shown to be rotatably supported with respect to the frame 12 adjacent to the rear end 15 of the motorcycle 10. In particular, the frame 12 is shown to comprise a swing-arm 38 which rotatably supports the rear wheel 16.

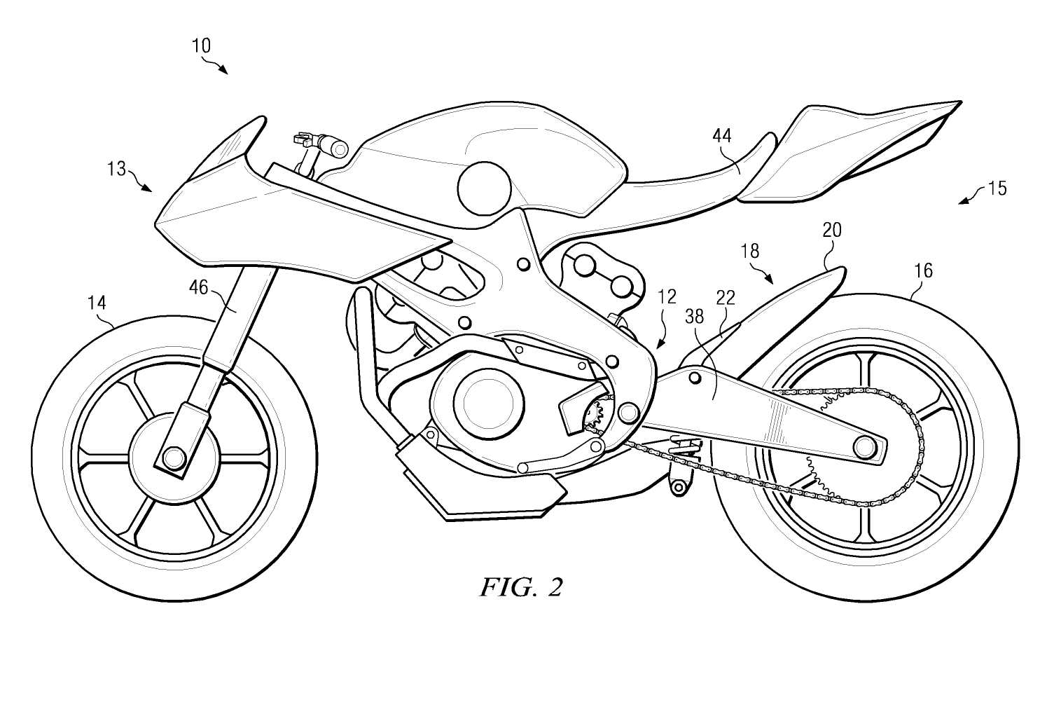

The motorcycle 10 can also comprise a fender assembly 18. The fender assembly 18 is shown as being positioned to cover a portion of the rear wheel 16. By covering a portion of the rear wheel 16 as shown in FIGS. 1-2, it can be seen that the fender assembly 18 can block debris from projecting or splashing from the rear wheel 16 and up onto an operator and/or other portions of the motorcycle 10. Although not specifically depicted, it will be appreciated that a fender assembly in accordance with an alternative embodiment can be positioned to cover a portion of a motorcycle's front wheel to block debris from projecting or splashing up from the front wheel and onto an operator and/or other portions of the motorcycle. Accordingly, a vehicle (e.g., a motorcycle) in accordance with various embodiments can include a fender assembly positioned to cover a portion of a front wheel, a fender assembly positioned to cover a portion of a rear wheel, or multiple fender assemblies positioned to respectively cover portions of front and rear wheels. It will be appreciated that debris can include mud, dirt, terrain, sticks, rocks, water, oil, grass, mulch, ash, sand, and/or any of a variety of other items or objects which may potentially be encountered by a vehicle.

Referring to FIGS. 1-4, the fender assembly 18 is shown to comprise a fender panel 20 and an arm 22. The arm 22 is attached to the fender panel 20 and is additionally configured to be attached with respect to the frame 12 of the motorcycle 10 for supporting the fender panel 20 with respect to the frame 12 of the motorcycle 10. For example, attachment of the arm 22 with respect to the frame 12 of the motorcycle 10 is shown in FIGS. 1-4 as being achieved through attachment of the arm 22 to the swing-arm 38 of the motorcycle 10. In an alternative embodiment, attachment of an arm of a fender assembly to or with respect to the frame of a vehicle (e.g., a motorcycle) can involve direct or indirect attachment of the arm to another portion of the vehicle's frame.

As shown in FIG. 3, the arm 22 can extend between a first end 24 and a second end 26. The first end 24 of the arm 22 can be attached to the fender panel 20 while the second end 26 of the arm 22 is shown to be attached to the swing-arm 38. In accordance with one embodiment, as shown in FIGS. 1-3, the arm 22 can extend at least partially over at least a portion of the rear wheel 16, and may thereby cover at least a portion of the rear wheel 16. In one embodiment, as shown in FIG. 3, the arm 22 may extend along the longitudinal axis 28 of the motorcycle 10 such that the arm 22 has a greater dimension in a direction parallel with the longitudinal axis 28 than in a direction perpendicular to the longitudinal axis 28. However, in an alternative embodiment, the arm can have an equal or greater dimension in a direction perpendicular to the longitudinal axis than in a direction parallel with the longitudinal axis.

The arm 22 may be formed from any of a variety of suitable materials such as, for example, metal, fiberglass, plastic, and/or carbon fiber. In one embodiment, the arm 22 comprises metal. The arm 22 may comprise any variety of shapes and dimensions suitable to facilitate attachment of the fender panel 20 with respect to the frame 12 of the motorcycle 10. It will be appreciated that the arm may optionally be provided with ribs and/or other structural features to enhance rigidity, strength, and durability as desired to reduce potential for cracking and/or breaking of the arm resulting from long-term use of the vehicle.

With reference to FIGS. 3-4, the fender panel 20 can include a top surface 34 and a bottom surface 36 which can be opposite the top surface 34. When the fender assembly 18 is attached to the motorcycle 10, as shown in FIGS. 1-2, the fender panel 20 may be positioned so as to cover at least a portion of the rear wheel 16. In this configuration, the bottom surface 36 of the fender panel 20 can obstruct debris from projecting or splashing from the rear wheel 16 and up onto an operator and/or other portions of the motorcycle 10. The fender panel 20 may be formed from any of a variety of suitable materials such as, for example, metal, fiberglass, plastic, and/or carbon fiber. It will be appreciated that the fender panel may optionally be provided with ribs and/or other structural features to enhance rigidity, strength, and durability as desired to reduce potential for cracking and/or breaking of the fender panel resulting from long-term use of the vehicle.

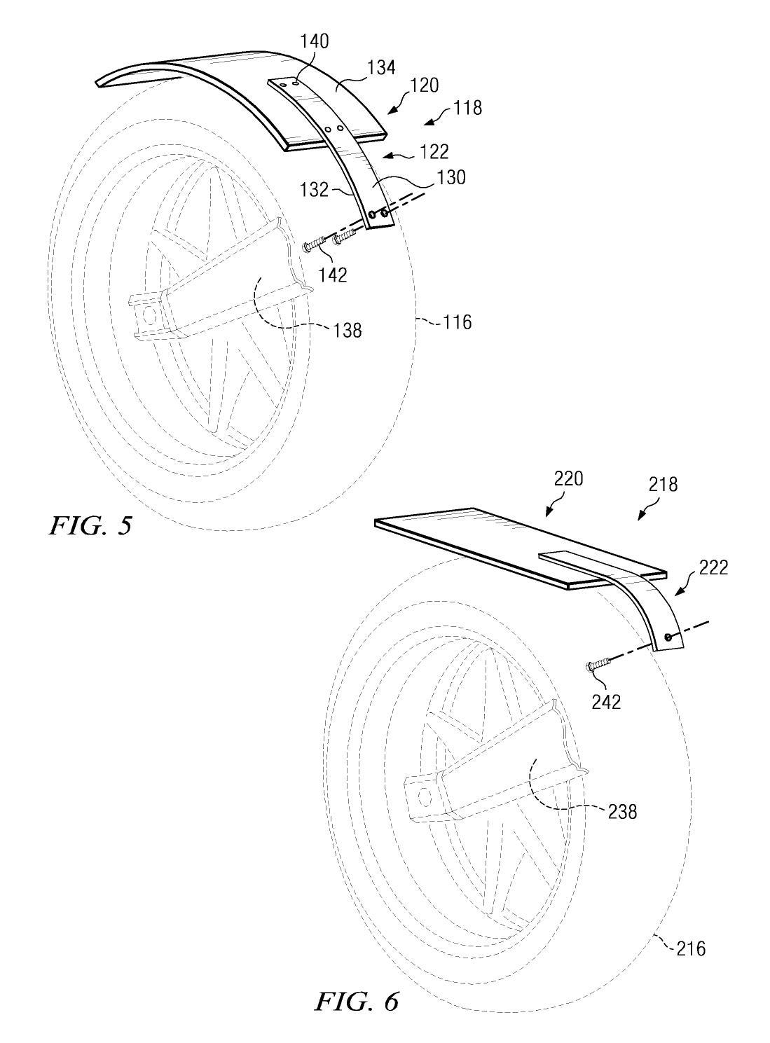

The fender panel 20 may have any of a variety of shapes and dimensions which are suitable to obstruct debris. For example, with reference to the embodiment of FIGS. 1-4, the fender panel 20 may generally comprise a pear-shape in which the fender panel 20 is broadest perpendicularly to the longitudinal axis 28 at a location of the fender panel 20 nearest the frame 12 of the motorcycle 10, but narrows as it extends to its point furthest from that location. However, fender panels in accordance with other embodiments can have any of a variety of other shapes and configurations (see, for example, the embodiments of FIGS. 5-6 discussed below). In one embodiment, as shown in FIGS. 1-4, the fender panel 20 may extend along the longitudinal axis 28 of the motorcycle 10 such that the fender panel 20 has a greater dimension in a direction parallel with the longitudinal axis 28 than in a direction perpendicular to the longitudinal axis 28. However, in an alternative embodiment, the fender panel can have an equal or greater dimension in a direction perpendicular to the longitudinal axis 28 than in a direction parallel with the longitudinal axis 28.

In accordance with one embodiment, as shown in FIGS. 3-4, the arm 22 of the fender assembly 18 can include an upper surface 30 and a lower surface 32. The lower surface 32 can be opposite the upper surface 30, and one of the upper surface 30 and the lower surface 32 can contact the fender panel 20. In particular, as shown in FIG. 4, at least a portion of the lower surface 32 of the arm 22 can contact the top surface 34 of the fender panel 20 to facilitate an attachment of the first end 24 of the arm 22 to the fender panel 20. Also, at least a portion of the upper surface 30 of the arm 22 can contact another portion of the motorcycle 10 to facilitate attachment of the second end 26 of the arm 22 to the other portion of the motorcycle 10. For example, FIG. 4 depicts a portion of the top surface 30 adjacent to the second end 26 of the arm 22 as being notched to correspond with a shape of the swing-arm 38 in order to facilitate attachment of the second end 26 of the arm 22 to the swing-arm 38.

It will be appreciated that, in other embodiments, a fender assembly can be configured such that an arm can be attached to a fender panel and with respect to a frame of a vehicle in any of a variety of alternative configurations. For example, in one embodiment, a lower surface of an arm can contact a swing-arm of a vehicle while an upper surface of the arm contacts a bottom surface of a fender panel. In another embodiment, a lower surface of an arm can contact both a swing-arm of a vehicle and a bottom surface of a fender panel. In yet another embodiment, an upper surface of an arm can contact both a swing-arm of a motorcycle and a bottom surface of a fender panel.

A single arm can at least substantially entirely support a fender panel at a position to cover at least a portion of a vehicle's wheel. It is to be understood that “at least substantially entirely” means that the single arm either substantially entirely supports or entirely supports the fender panel with respect to the vehicle, such that no additional attachment is needed or provided between the fender panel and the remainder of the vehicle. Accordingly, such a vehicle might not include any additional arms or attachment points to facilitate attachment of the fender panel. In the embodiment of FIGS. 1-3, the arm 22 is shown to entirely support the fender panel 20 at a position to cover a portion of the rear wheel 16 of the motorcycle 10. In this configuration, there is no need for the fender panel 18 to be attached to an operator's seat (e.g., 44 in FIGS. 1-2) or another portion of the motorcycle 10 as is common of certain conventional motorcycles. Also, in the embodiment of FIGS. 1-4, if the arm 22 is disconnected from the swing-arm 38 (e.g., by removal of bolts 42), the entire fender assembly 18 can be removed from the motorcycle 10. It will be appreciated that use of a single arm (as opposed to multiple arms or members) to facilitate attachment of a fender assembly to another component (e.g., a frame) of a vehicle can achieve manufacturing, cost, weight, bulk, and aesthetic advantages.

A fender assembly in accordance with another embodiment can be provided for use with a front wheel of a vehicle. For example, the fender assembly can include an arm which at least substantially entirely supports a fender panel at a position to cover at least a portion of a front wheel (e.g., 14 in FIGS. 1-2) of a vehicle such as a motorcycle. In such circumstances, the arm might attach to a portion of a motorcycle's frame (e.g., 12 in FIGS. 1-2) and/or fork (e.g., 46 in FIGS. 1-2), and may extend at least partially over at least a portion of the front wheel. Thereby, a fender panel attached to the arm may also extend at least partially over, and thus cover, at least a portion of the front wheel for blocking debris from projecting or splashing up from the front wheel and onto an operator and/or other portions of the motorcycle. Again, it will be appreciated that a vehicle (e.g., a motorcycle) in accordance with various embodiments can include one or more fender assemblies associated with one or both of the front and rear wheels of the vehicle.

Referring now to FIG. 4, in order to assemble and install the fender assembly 18 upon the motorcycle 10, a portion of the lower surface 32 of the arm 22 adjacent to the first end 24 of the arm 22 can be placed into contact with and attached to a top surface 34 of the fender panel 20. This attachment can be achieved through use of any of a variety of techniques including but not limited to those involving use of fasteners (e.g., bolts, screws, rivets, pins, or otherwise), adhesives, interlocking mechanical features, welding, and/or otherwise. For example, one or more bolts (e.g., 40) may be inserted from beneath the fender panel 20, through apertures in the fender panel 20, and into threaded apertures provided in the lower surface 32 of the arm 22. In this manner, bolt(s) (e.g., 40), for example, can secure an attachment between the arm 22 and the fender panel 20. However, it is contemplated that bolts alternatively inserted from a variety of different approaches can facilitate attachment of the arm 22 to the fender panel 20. It is also contemplated that an attachment between the arm 22 and the fender panel 20 can be achieved through use of adhesives and/or some other arrangement not involving fasteners. In still another embodiment, an arm and a fender panel can be attached together as a unitary structure such as through use of a common molding or casting process.

A portion of the arm 22 adjacent to the second end 26 of the arm 22 (e.g., a portion of the upper surface 30 of the arm 22) can be placed into contact with and attached to another portion of a vehicle (e.g., a swing-arm 38 of the motorcycle 10). This attachment can be achieved through use of any of a variety of techniques including but not limited to those involving use of fasteners (e.g., bolts, screws, rivets, pins, or otherwise), adhesives, interlocking mechanical features, welding, and/or otherwise. For example, one or more bolts (e.g., 42) may be inserted from beneath and through apertures in the other vehicle portion (e.g., the swing-arm 38), and into threaded apertures provided in the arm 22 (e.g., in the upper surface 30 of the arm 22). In this manner, the bolt(s) (e.g., 42), for example, can secure an attachment between the arm 22 and another vehicle portion (e.g., the swing-arm 38). However, it is contemplated that bolts can alternatively be inserted from a variety of different approaches to facilitate attachment of an arm to another vehicle portion, and/or that an arm can be attached to another vehicle portion (e.g., a swing-arm) through use of adhesives, welding, interlocking mechanical features, and/or some other arrangement not involving fasteners. In still another embodiment, an arm and another portion of a vehicle (e.g., a swing-arm) can be attached together as a unitary structure such as through use of a common molding or casting process. Although FIGS. 1-4 depict attachment of the second end 26 of the arm 22 to the swing-arm 38 of the motorcycle 10, it will be appreciated that the second end 26 of the arm 22 might alternatively be configured for attachment to a different part of the motorcycle 10 (e.g., to another part of the frame 12 and/or to the seat 44).

It will be appreciated that a fender assembly can be provided in any of a variety of suitable alternative configurations. For example, as shown in FIG. 5, a fender assembly 118 can comprise a fender panel 120 and an arm 122. The fender panel 120 is shown to have the shape of a rectangular plate which has been bent to generally correspond with the curvature of an associated rear wheel 116. A portion of a lower surface 132 of the arm 122 is shown to contact a top surface 134 of the fender panel 120, and fasteners (e.g., 140, such as bolts or rivets) can facilitate attachment of the arm 122 to the fender panel 120. However, adhesives, welding, interlocking mechanical features, and/or any of a variety of other techniques or arrangements can additionally or alternatively be provided to facilitate attachment of the arm 122 to the fender panel 120. A portion of an upper surface 130 of the arm 122 can contact another portion (e.g., a swing-arm 138 or frame) of an associated vehicle (e.g., a motorcycle) to facilitate attachment of the fender assembly 118 to the remainder of the vehicle such that the fender assembly 120 extends at least partially over a wheel (e.g., a rear wheel 116) of the vehicle. While bolts 142 are depicted in FIG. 5, it will be appreciated that adhesives, welding, interlocking mechanical features, and/or any of a variety of other techniques or arrangements can additionally or alternatively be employed to facilitate attachment of the fender assembly 118 to the remainder of the vehicle.

FIG. 6 depicts a fender assembly 218 in accordance with yet another embodiment. The fender assembly 218 is shown to include a fender panel 220 which is attached to an arm 222 such as through use of interlocking mechanical features, adhesives, welding, and/or fasteners. The fender panel 220 is shown to be generally planar and rectangular. The fender assembly 220 can be configured for attachment (e.g., through use of bolt 242) to a frame or swing-arm 238 of a motorcycle or other vehicle such that the fender assembly 220 extends at least partially over a wheel (e.g., a rear wheel 216) of the vehicle. It will be appreciated that the structure and function of the fender assemblies 118, 218 of FIGS. 5-6, respectively, can be substantially as described above with respect to the fender assembly 18 of FIGS. 1-4, though the shapes and attachment configurations of the fender panels 20, 120, 220 and arms 22, 122, 222 are shown to differ.

The foregoing description of embodiments and examples of the invention has been presented for purposes of illustration and description. It is not intended to be exhaustive or to limit the invention to the forms described. Numerous modifications are possible in light of the above teachings. Some of those modifications have been discussed and others will be understood by those skilled in the art. The embodiments were chosen and described in order to best illustrate the principles of the invention and various embodiments as are suited to the particular use contemplated. The scope of the invention is, of course, not limited to the examples or embodiments set forth herein, but can be employed in any number of applications and equivalent devices by those of ordinary skill in the art. Rather it is hereby intended the scope of the invention be defined by the claims appended hereto.

What is claimed is:

1. A motorcycle comprising:
a frame;
a front wheel rotatably supported with respect to the frame;
a rear wheel rotatably supported with respect to the frame;
a fender assembly comprising a fender panel and an arm, wherein the arm has a first end and a second end, the first end is attached to the fender panel, the second end is attached to the frame, and the arm extends along a longitudinal axis of the motorcycle and at least substantially entirely supports the fender panel at a position to cover at least a portion of one of the front wheel and the rear wheel.

2. The motorcycle of claim 1, wherein the arm comprises a first surface and a second surface opposite the first surface, wherein one of the first surface and the second surface contacts the fender panel.

3. The motorcycle of claim 2, wherein the fender panel comprises a top surface and a bottom surface opposite the top surface, and the first surface of the arm contacts the top surface of the fender panel.

4. The motorcycle of claim 3, wherein the second surface of the arm contacts the frame.

5. The motorcycle of claim 1, wherein the frame comprises a swing-arm rotatably supporting the rear wheel, and the second end of the arm is attached to the swing-arm.

6. The motorcycle of claim 5, wherein the second surface of the arm contacts the swing-arm.

7. The motorcycle of claim 1, wherein the arm entirely supports the fender panel at a position to cover at least a portion of the rear wheel.

8. The motorcycle of claim 7, wherein the arm extends at least partially over at least a portion of the rear wheel.

9. The motorcycle of claim 1, wherein the arm comprises metal.

10. The motorcycle of claim 1, wherein the fender panel extends along the longitudinal axis of the motorcycle.

11. A vehicle comprising:
a frame;
a front wheel rotatably supported with respect to the frame;
a rear wheel rotatably supported with respect to the frame;
a fender assembly comprising:
a fender panel having a top surface and a bottom surface; and
an arm having a first end, a second end, an upper surface and a lower surface;
wherein the first end of the arm is attached to the fender panel such that the lower surface of the arm contacts the top surface of the fender panel; and
wherein the second end of the arm is attached to the frame, the arm and the fender panel extend along a longitudinal axis of the vehicle, the arm extends at least partially over at least a portion of the rear wheel, and the arm at least substantially entirely supports the fender panel at a position to cover at least a portion of the rear wheel.

12. The vehicle of claim 11, wherein the frame comprises a swing-arm, the rear wheel is attached to the swing-arm, and the upper surface of the arm contacts the swing-arm.

13. The vehicle of claim 12 comprising a motorcycle.

14. The vehicle of claim 13, wherein the arm comprises metal.

15. A fender assembly for a vehicle, the fender assembly comprising:
a fender panel; and
an arm having a first end and a second end, wherein the first end is attached to the fender panel and the second end is configured for attachment with respect to a frame of a vehicle such that the arm at least substantially entirely supports the fender panel at a position to cover at least a portion of a wheel of the vehicle.

16. The fender assembly of claim 15, wherein the arm comprises an upper surface and a lower surface opposite the upper surface, and one of the upper surface and the lower surface contacts the fender panel.

17. The fender assembly of claim 16, wherein the fender panel comprises a top surface and a bottom surface opposite the top surface, and the lower surface of the arm contacts the top surface of the fender panel.

18. The fender assembly of claim 17, wherein the upper surface of the arm is configured for contacting a vehicle's frame.

19. The fender assembly of claim 15, wherein the arm comprises metal.

20. The fender assembly of claim 15 being configured for attachment to a frame of a motorcycle to cover at least a portion of a rear wheel.
